(19) United States
(12) Patent Application Publication
(10) Pub. No.: US 2024/0345228 A1
(43) Pub. Date: Oct. 17, 2024

(54) ELECTROMAGNETIC WAVE RADIATION DEVICE, RANGING DEVICE, AND MOBILE OBJECT

(71) Applicant: KYOCERA Corporation, Kyoto (JP)

(72) Inventor: Susumu KASHIWASE, Machida-shi, Tokyo (JP)

(73) Assignee: KYOCERA Corporation, Kyoto (JP)

(21) Appl. No.: 18/703,466

(22) PCT Filed: Oct. 11, 2022
(86) PCT No.: PCT/JP2022/037939

§ 371 Date: Apr. 22, 2024

(30) Foreign Application Priority Data
Oct. 27, 2021 (JP) 2021-175987

(51) Int. Cl. G01S 7/484; G01S 17/10; G01S 17/88

(52) U.S. Cl. CPC G01S 7/484; G01S 17/10; G01S 17/88

(57) ABSTRACT

An electromagnetic wave radiation device includes multiple electromagnetic wave radiation circuits, a radiation switching element, and a controller. Each electromagnetic wave radiation circuit includes an electromagnetic wave radiation element, a capacitor, and a discharging switching element. The radiation switching element is connected to the cathode side of the multiple electromagnetic wave radiation elements included in the multiple electromagnetic wave radiation circuits The radiation switching element is capable of energizing the multiple electromagnetic wave radiation elements. The controller discharges the capacitor in any one electromagnetic wave radiation circuit, among the multiple electromagnetic wave radiation circuits, after causing the electromagnetic wave radiation element in the one electromagnetic wave radiation circuit to radiate using the radiation switching element and before causing the electromagnetic wave radiation element in another electromagnetic wave radiation circuits to radiate light.

### CROSS-REFERENCE TO RELATED APPLICATIONS

This application claims priority from Japanese Patent Application No. 2021-175987 filed in Japan on Oct. 27, 2021, and the entire disclosure of this application is hereby incorporated by reference.

### TECHNICAL FIELD

The present disclosure relates to an electromagnetic wave radiation device, a ranging device, and a mobile object.

### BACKGROUND OF INVENTION

A known ranging device is configured to measure the distance to an object that is to be subjected to ranging by radiating light onto the object and dividing the time taken to receive reflected scattered light by the speed of light (see Patent Literature 1).

### CITATION LIST

### Patent Literature

Patent Literature 1: Japanese Unexamined Patent Application Publication No. 2016-053552

### SUMMARY

In a First Aspect, an electromagnetic wave radiation device includes multiple electromagnetic wave radiation circuits, a radiation switching element, and a controller.

Each electromagnetic wave radiation circuit includes an electromagnetic wave radiation element, a capacitor configured to supply current to the electromagnetic wave radiation element, and a discharging switching element configured to discharge the capacitor.

The radiation switching element is connected to a cathode side of the multiple electromagnetic wave radiation elements included in the multiple electromagnetic wave radiation circuits and configured to be capable of energizing the multiple electromagnetic wave radiation elements. The controller is configured to discharge the capacitor in any one electromagnetic wave radiation circuit, among the multiple electromagnetic wave radiation circuits, after causing the electromagnetic wave radiation element in the one electromagnetic wave radiation circuit to radiate light and before causing the electromagnetic wave radiation element in another electromagnetic wave radiation circuit, among the multiple electromagnetic wave radiation circuits, to radiate light.

In a Second Aspect, a ranging device includes an electromagnetic wave radiation device.

The ranging device is configured to measure a distance to an object using an electromagnetic wave radiated from the electromagnetic wave radiation device.

The electromagnetic wave radiation device includes multiple electromagnetic wave radiation circuits, a radiation switching element, and a controller.

Each electromagnetic wave radiation circuit includes an electromagnetic wave radiation element, a capacitor configured to supply current to the electromagnetic wave radiation element, and a discharging switching element configured to discharge the capacitor.

The radiation switching element is connected to a cathode side of the multiple electromagnetic wave radiation elements included in the multiple electromagnetic wave radiation circuits and is configured to be capable of energizing the multiple electromagnetic wave radiation elements. The controller is configured to discharge the capacitor in any one electromagnetic wave radiation circuit, among the multiple electromagnetic wave radiation circuits, after causing the electromagnetic wave radiation element in the one electromagnetic wave radiation circuit to radiate light and before causing the electromagnetic wave radiation element in another electromagnetic wave radiation circuit, among the multiple electromagnetic wave radiation circuits, to radiate light.

Each of the electromagnetic wave radiation circuits includes a charging switching element configured to charge the capacitor of the electromagnetic wave radiation circuit.

The controller is configured to control the charging switching element and the discharging switching element and make a discharging time longer than a charging time.

The controller is configured to start discharging the capacitor in the one electromagnetic wave radiation circuit using the discharging switching element after elapsing of a prescribed ranging time from after the electromagnetic wave radiation element in the one electromagnetic wave radiation circuit radiates light.

In a Third Aspect, a mobile object includes a ranging device.

The ranging device includes an electromagnetic wave radiation device.

The ranging device is configured to measure a distance to an object using an electromagnetic wave radiated from the electromagnetic wave radiation device.

The electromagnetic wave radiation device includes multiple electromagnetic wave radiation circuits, a radiation switching element, and a controller.

Each electromagnetic wave radiation circuit includes an electromagnetic wave radiation element, a capacitor configured to supply current to the electromagnetic wave radiation element, and a discharging switching element configured to discharge the capacitor.

The radiation switching element is connected to a cathode side of the multiple electromagnetic wave radiation elements included in the multiple electromagnetic wave radiation circuits and is configured to be capable of energizing the multiple electromagnetic wave radiation elements. The controller is configured to discharge the capacitor in any one electromagnetic wave radiation circuit, among the multiple electromagnetic wave radiation circuits, after causing the electromagnetic wave radiation element in the one electromagnetic wave radiation circuit to radiate light and before causing the electromagnetic wave radiation element in another electromagnetic wave radiation circuits, among the multiple electromagnetic wave radiation circuits, to radiate light.

Each of the electromagnetic wave radiation circuits includes a charging switching element configured to charge the capacitor of the electromagnetic wave radiation circuit.

The controller is configured to control the charging switching element and the discharging switching element and make a discharging time longer than a charging time.

The controller is configured to start discharging the capacitor in the one electromagnetic wave radiation circuit using the discharging switching element after elapsing of a prescribed ranging time from after the electromagnetic wave radiation element in the one electromagnetic wave radiation circuit radiates light.

### BRIEF DESCRIPTION OF THE DRAWINGS

FIG. 1 is an arrangement diagram illustrating the arrangement of a ranging device in a mobile object, the ranging device including an electromagnetic wave radiation device according to this embodiment.

FIG. 2 is a functional block diagram illustrating a schematic configuration of the ranging device in FIG. 1.

FIG. 3 is a circuit diagram illustrating a circuit configuration of the electromagnetic wave radiation device in FIG. 1.

FIG. 4 is a timing chart illustrating the control timings of a radiation switching element, and a charging switching element and a discharging switching element in each electromagnetic wave radiation circuit as controlled by a controller in FIG. 3.

FIG. 5 is a timing chart illustrating the timing of radiation of electromagnetic waves and the timing of detection in order to explain the principles of ranging performed by the ranging device in FIG. 1.

### DESCRIPTION OF EMBODIMENTS

An embodiment of the present disclosure is described below while referring to the drawings. In the components illustrated in the drawings referred to below, the same symbols are used for the same components.

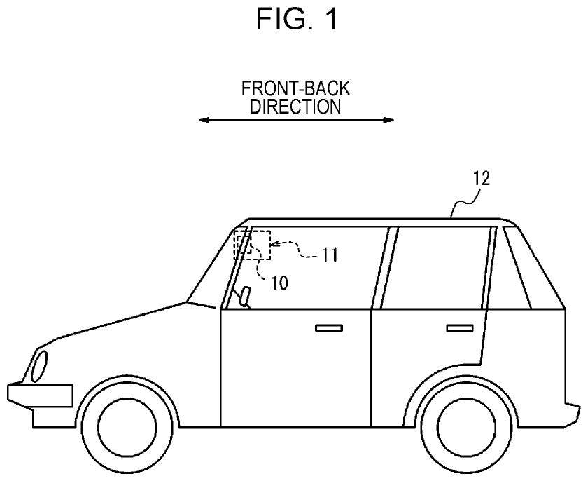

As illustrated in FIG. 1, a ranging device 11 includes an electromagnetic wave radiation device 10 of the present disclosure. The ranging device 11 is, for example, is provided in a mobile object 12.

Examples of the mobile object 12 may include vehicles, ships, and aircraft. Vehicles may include, for example, automobiles, industrial vehicles, rail vehicles, motorhomes, and fixed-wing aircraft that taxi along runways. Automobiles may include, for example, passenger cars, trucks, buses, motorcycles, and trolleybuses. Industrial vehicles may include, for example, industrial vehicles used in agriculture and construction. Industrial vehicles may include, for example, forklift trucks and golf carts. Industrial vehicles used in agriculture may include, for example, tractors, cultivators, transplanters, binders, combine harvesters, and lawn mowers. Industrial vehicles used in construction may include, for example, bulldozers, scrapers, excavators, cranes, dump trucks, and road rollers. Vehicles may include vehicles that are human powered. The categories of vehicles are not limited to the above examples. For example, automobiles may include industrial vehicles that can travel along roads. The same vehicles may be included in multiple categories. Ships may include, for example, jet skis, boats, and tankers. Aircraft may include, for example, fixed-wing and rotary-wing aircraft.

The ranging device 11 may be provided in the mobile object 12 so that the directional range in which ranging is desired to be performed is included in a measurement directional range. The ranging device 11 is provided, for example, so that a directional range centered on a region in front of the mobile object 12 is included in the measurement directional range. The ranging device 11 may be provided inside or outside the mobile object 12. The ranging device 11 may be disposed inside the mobile object 12, for example, in front of the rearview mirror near the windshield or on the dashboard. The ranging device 11 may be fixed to any of a front bumper, a fender grille, a side fender, a light module, and a hood of the mobile object 12.

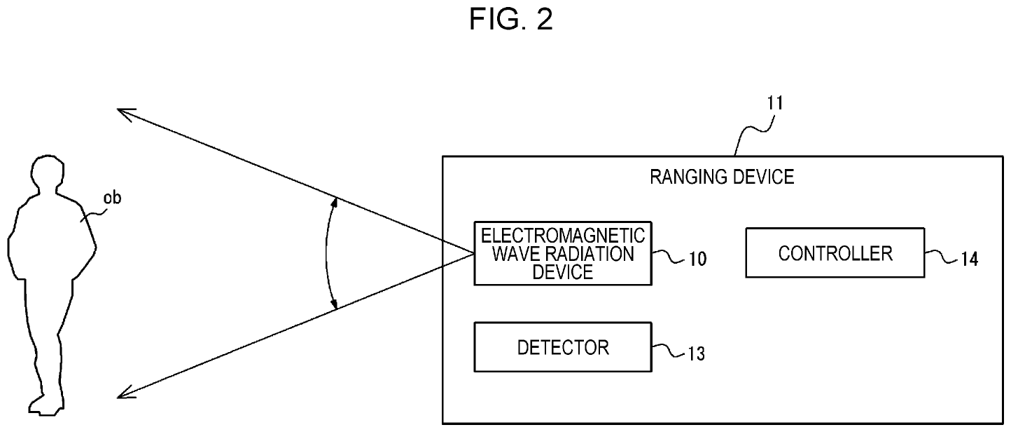

As illustrated in FIG. 2, the ranging device 11 includes the electromagnetic wave radiation device 10, a detector 13, and a controller 14. The ranging device 11 radiates measurement electromagnetic waves into space. The measurement electromagnetic waves are, for example, measurement light. In the following description, descriptions relating to electromagnetic waves will be given using measurement light as an example. The ranging device 11 detects reflected scattered light from measurement light radiated on an object ob in space. The ranging device 11 may generate distance information by performing ranging on an object located in a radiation direction of the measurement light based on the reflected scattered light.

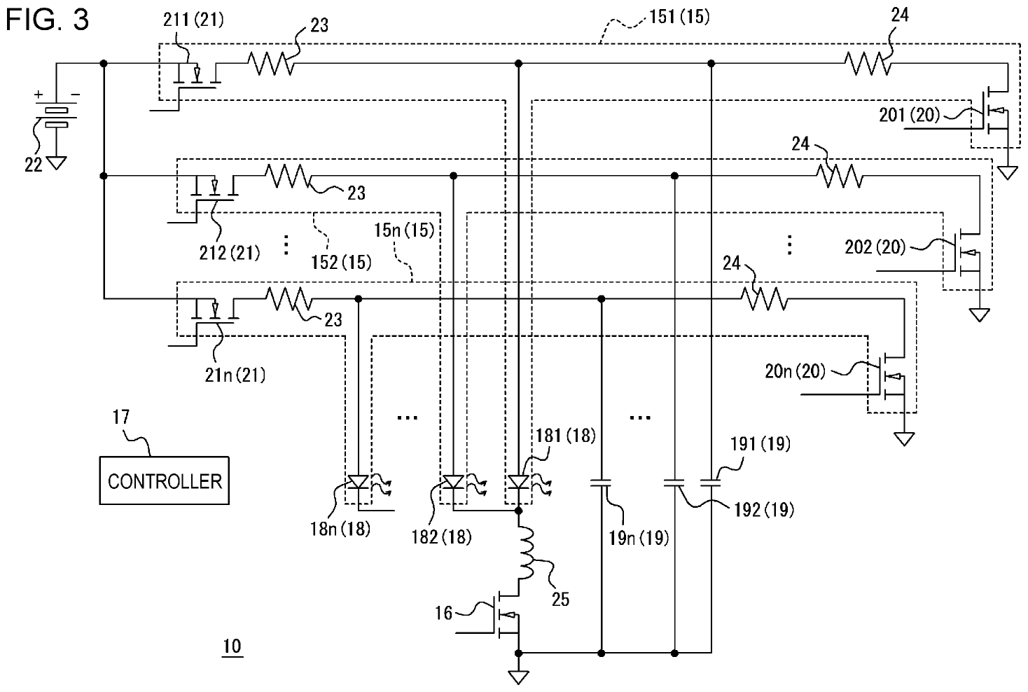

As illustrated in FIG. 3, the electromagnetic wave radiation device 10 includes multiple electromagnetic wave radiation circuits 15, a radiation switching element 16, and a controller 17. The multiple electromagnetic wave radiation circuits 15 may be connected in parallel with each other. The multiple electromagnetic wave radiation circuits 15 and the radiation switching element 16 may be mounted on a semiconductor circuit board. Although FIG. 3 illustrates the electromagnetic wave radiation device 10 including three or more electromagnetic wave radiation circuits 15 as an example, there may be two or more electromagnetic wave radiation circuits 15 included in the electromagnetic wave radiation device 10.

Each electromagnetic wave radiation circuit 15 includes an electromagnetic wave radiation element 18, a capacitor 19, and a discharging switching element 20. Each electromagnetic wave radiation circuit 15 may include a charging switching element 21.

The electromagnetic wave radiation element 18 radiates measurement light. The electromagnetic wave radiation element 18 may radiate measurement light such as infrared light, visible light, or ultraviolet light. The electromagnetic wave radiation element 18 may radiate a beam of measurement light that is, for example, 0.5° in width. The electromagnetic wave radiation element 18 is, for example, a laser diode. The electromagnetic wave radiation element 18 emits light when energized and radiates measurement light.

The capacitor 19 is connected in parallel with the electromagnetic wave radiation element 18. The capacitor 19 supplies an electrical current to the electromagnetic wave radiation element 18. The capacitor 19 may be connected to a power supply 22, which is shared by the multiple electromagnetic wave radiation circuits 15, via the charging switching element 21. More specifically, the capacitor 19 may be connected to the power supply 22 at a terminal connected to the anode side of the electromagnetic wave radiation element 18.

A first resistor 23 may be provided between the capacitor 19 and the charging switching element 21. The resistance value of the first resistor 23 may be set so that the time required for charging and discharging is an appropriate amount of time, for example, from several us to several hundred μs. By optimizing the charging time and the discharging time, the emission interval is restricted to an emission interval specified by laser safety standards. The emission interval of the same laser element is desirably set to 5 μs or more, since emissions at intervals of 5 μs or less are treated as identical pulses.

An inductor of an appropriate value may be installed in place of the first resistor 23 to limit the charging current. In the configuration in which an inductor is installed, the charging voltage to the capacitor 19 is boosted. Furthermore, in this configuration, the voltage is boosted to a higher voltage due to the capacitor 19 being charged in a state where the capacitor 19 has been discharged.

When energized, the charging switching element 21 causes the capacitor 19 to be charged. The energizing and de-energizing of the charging switching element 21 is controlled by the controller 17. The charging switching element 21 is, for example, an FET (field effect transistor).

The discharging switching element 20 is connected in parallel with the capacitor 19. A second resistor 24 may be provided between the capacitor 19 and the discharging switching element 20. The resistance value of the second resistor 24 may be set so that charging and discharging take an appropriate amount of time. When energized, the discharging switching element 20 causes the capacitor 19 to discharge. The energizing and de-energizing of the discharging switching element 20 is controlled by the controller 17. The discharging switching element 20 is, for example, an FET (field effect transistor). The gate charge capacity of the discharging switching element 20 may be larger than the gate charge capacity of the charging switching element 21.

The radiation switching element 16 may be connected to the cathodes of the multiple electromagnetic wave radiation elements 18 included in the multiple electromagnetic wave radiation circuits 15. The radiation switching element 16 may be connected to the cathode side of the multiple electromagnetic wave radiation elements 18 included in the multiple electromagnetic wave radiation circuits 15, for example, with a resistor provided therebetween. An inductor 25 may be provided between the multiple electromagnetic wave radiation elements 18 and the radiation switching element 16. When energized, the radiation switching element 16 can cause the multiple electromagnetic wave radiation elements 18 to be energized and emit light. The energizing and de-energizing of the radiation switching element 16 is controlled by the controller 17. The radiation switching element 16 is, for example, an FET (field effect transistor).

The controller 17 includes one or more processors and memories. Such processors may include at least either of general-purpose processors into which specific programs are loaded in order to perform specific functions and dedicated processors dedicated to specific processing. Dedicated processors may include an ASIC (application specific integrated circuit). Processors may include PLDs (programmable logic devices). PLDs may include FPGAs (field-programmable gate arrays). The controller 17 may include at least either one of an SoC (system-on-a-chip) and an SiP (system in a package), in which one or more processors work together.

The controller 17 energizes and de-energizes at least the radiation switching element 16 and the discharging switching elements 20 based on commands from the controller 14 of the ranging device 11. The controller 17 may also energize and de-energize the charging switching elements 21. The control of energizing and de-energizing of the radiation switching element 16, the discharging switching elements 20, and the charging switching elements 21 is described below.

The controller 17 may select the multiple electromagnetic wave radiation circuits 15 in sequence and cause the electromagnetic wave radiation element 18 in the selected electromagnetic wave radiation circuit 15 to radiate measurement light, as described below. The controller 17 may charge the capacitor 19 in the selected electromagnetic wave radiation circuit 15 by energizing the charging switching element 21 in the selected electromagnetic wave radiation circuit 15. The controller 17 may then cause the measurement light to be radiated by energizing the electromagnetic wave radiation element 18 of the same electromagnetic wave radiation circuit 15 from the charged capacitor 19 by energizing the radiation switching element 16. The controller 17 may discharge the capacitor 19 in the same electromagnetic wave radiation circuit 15 by energizing the discharging switching element 20 in that electromagnetic wave radiation circuit 15.

In the present disclosure, more specifically, the controller 17 controls the radiation switching element 16 so as to energize the electromagnetic wave radiation element 18 in any one electromagnetic wave radiation circuit 15 among the multiple electromagnetic wave radiation circuits 15. The controller 17 discharges the capacitor 19 using the discharging switching element 20 in that one electromagnetic wave radiation circuit 15 after the electromagnetic wave radiation element 18 in that one electromagnetic wave radiation circuit 15 is made to radiate light by being energized and before the electromagnetic wave radiation element 18 in any other electromagnetic wave radiation circuit 15 other than that one electromagnetic wave radiation circuit 15 is made to radiate light by being energized. Furthermore, the controller 17 may discharge the capacitors 19 using the respective discharging switching elements 20 in all the electromagnetic wave radiation circuits 15 other than that other electromagnetic wave radiation circuit 15 before energizing the electromagnetic wave radiation element 18 in that other electromagnetic wave radiation circuit 15.

The controller 17 may cause the capacitor 19 in any single electromagnetic wave radiation circuit 15 to start discharging using the corresponding discharging switching element 20 after a prescribed ranging time has elapsed from after the electromagnetic wave radiation element 18 in that electromagnetic wave radiation circuit 15 is made to radiate light by being energized. The prescribed ranging time is a time for measuring the distance to an object by receiving reflected waves of electromagnetic waves reflected by the object. More specifically, the prescribed ranging time is half the designed maximum ranging distance of the ranging device 11 divided by the speed of light. The controller 17 controls the charging switching elements 21 and the discharging switching elements 20 so that the capacitors 19 are not charged or discharged during ranging. The controller 17 controls the charging switching elements 21 and the discharging switching elements 20 so that the capacitors 19 are charged and discharged before ranging is performed. Since the ranging device 11 performs control using the controller 17 so that the capacitors 19 are not charged or discharged during ranging, the possibility of noise being introduced into the detection signal of the detector 13 can be reduced.

The controller 17 may control the charging switching elements 21 and the discharging switching elements 20 so that the discharging time of the capacitors 19 is longer than the charging time of the capacitors 19. Alternatively, the controller 17 may control the charging switching elements 21 and the discharging switching elements 20 so that the charging time and the discharging time of the capacitors 19 are identical. Alternatively, the controller 17 may control the charging switching elements 21 and the discharging switching elements 20 so that the charging time of the capacitors 19 is longer than the discharging time of the capacitors 19.

Hereafter, a specific example of the control of the radiation switching elements 16, the discharging switching elements 20, and the charging switching elements 21 in the multiple electromagnetic wave radiation circuits 15 performed by the controller 17 is described. In the following description, the multiple electromagnetic wave radiation circuits 15 are respectively referred to as a first electromagnetic wave radiation circuit 151, a second electromagnetic wave radiation circuit 152, . . . , and an nth electromagnetic wave radiation circuit 15n. n is a natural number greater than or equal to 3. The electromagnetic wave radiation element 18, the capacitor 19, and the discharging switching element 20 included in the first electromagnetic wave radiation circuit 151 are respectively referred to as a first electromagnetic wave radiation element 181, a first capacitor 191, and a first discharging switching element 201. The electromagnetic wave radiation element 18, the capacitor 19, and the discharging switching element 20 included in the second electromagnetic wave radiation circuit 152 are respectively referred to as a second electromagnetic wave radiation element 182, a second capacitor 192, and a second discharging switching element 202. The electromagnetic wave radiation element 18, the capacitor 19, and the discharging switching element 20 included in the nth electromagnetic wave radiation circuit 15n are respectively referred to as an nth electromagnetic wave radiation element 18n, a nth capacitor 19n, and an nth discharging switching element 20n.

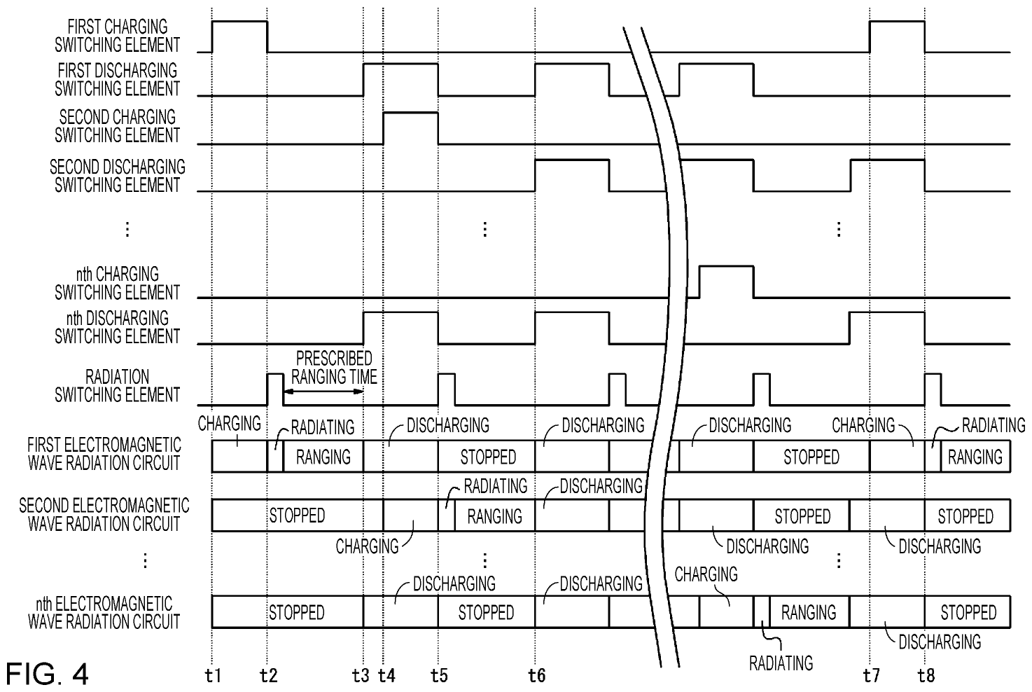

As illustrated in FIG. 4, at a timing t1, the controller 17 starts charging the first capacitor 191 by starting energization of a first charging switching element 211 (see “first charging switching element” section). At a timing t2, after the elapse of a prescribed charging time from the timing t1, the controller 17 de-energizes the first charging switching element 211 (see “first charging switching element” section), thereby terminating the charging of the first capacitor 191 (see “first electromagnetic wave radiation circuit” section).

At the timing t2, the controller 17 energizes the radiation switching element 16 (see “radiation switching element” section), thereby causing the first electromagnetic wave radiation element 181 to emit light and radiate the measurement light (see “first electromagnetic wave radiation circuit” section).

At a timing t3, which is after the elapse of the prescribed ranging time from the end of emission of light from the first electromagnetic wave radiation element 181, the controller 17 energizes all the discharging switching elements 20 other than the second discharging switching element 202 (see “first discharging switching element” section and “nth discharging switching element” section), and thereby discharges all of the capacitors 19 other than the second capacitor 192 (see “first electromagnetic wave radiation circuit” section and “nth electromagnetic wave radiation circuit” section).

At a timing t4 after all the discharging switching elements 20 except the second discharging switching element 202 have been energized, the controller 17 starts charging the second capacitor 192 by starting energization of a second charging switching element 212 (see “second charging switching element” section). At a timing t5, after the elapse of the prescribed charging time from the timing t4, the controller 17 de-energizes all the discharging switching elements 20 except for the second discharging switching element 202 (see “first discharging switching element” section and “nth discharging switching element” section), thereby terminating the discharge of all the capacitors 19 except for the second capacitor 192 (see “first electromagnetic wave radiation circuit” section and “nth electromagnetic wave radiation circuit” section). At the timing t5, the controller 17 also de-energizes the second charging switching element 212 (see “second charging switching element” section) so as to terminate charging of the second capacitor 192 (see “second electromagnetic wave radiation circuit” section). The controller 17 controls the second charging switching element 212 and all the discharging switching elements 20 except for the second discharging switching element 202 so that the charging of the second capacitor 192 and the discharging of all the capacitors 19 except for the second capacitor 192 are terminated at the timing t5. Since the ranging device 11 performs control using the controller 17 so that the capacitors 19 are not charged or discharged during ranging, the possibility of noise being introduced into the detection signal of the detector 13 can be reduced.

At the timing t5, the controller 17 energizes the radiation switching element 16 (see “radiation switching element” section), thereby causing the second electromagnetic wave radiation element 182 to emit light and radiate the measurement light (see “second electromagnetic wave radiation circuit” section).

At a timing t6, which is after the elapse of the prescribed ranging time from the end of emission of light from the second electromagnetic wave radiation element 182, the controller 17 energizes the respective discharging switching elements 20 of all the electromagnetic wave radiation elements 18 other than the electromagnetic wave radiation element 18 that is to emit light subsequent to the second electromagnetic wave radiation element 182 (see “second discharging switching element” section and “nth discharging switching element” section), and thereby discharges all of the capacitors 19 other than the electromagnetic wave radiation element 18 that is to emit light next (see “first electromagnetic wave radiation circuit” section, “second electromagnetic wave radiation circuit” section and “nth electromagnetic wave radiation circuit” section). The controller 17 controls the second charging switching element 212 and all the discharging switching elements 20 other than the second discharging switching element 202 so that charging of the second capacitor 192 and discharging of all capacitors 19 other than the second capacitor 192 are not performed during the period between the timing t5 and the timing t6 in which radiating and ranging are performed in the second electromagnetic wave radiation circuit. Since the ranging device 11 performs control using the controller 17 so that the capacitors 19 are not charged or discharged during ranging, the possibility of noise being introduced into the detection signal of the detector 13 can be reduced.

After that, the controller 17 charges the capacitor 19, causes the electromagnetic wave radiation element 18 to radiate light, and discharges the capacitor 19 in each electromagnetic wave radiation circuit 15 by performing processing similar to that for the first electromagnetic wave radiation circuit 151 and the second electromagnetic wave radiation circuit 152.

At a timing t7 after the nth discharging switching element 20 in the nth electromagnetic wave radiation circuit 15n, which is selected last among the multiple electromagnetic wave radiation circuits 15, has been energized, the controller 17 starts charging the first capacitor 191 by starting energization of the first charging switching element 211 (see “first charging switching element” section).

At a timing t8, after the elapse of the prescribed charging time from the timing t7, the controller 17 de-energizes all the discharging switching elements 20 except for the first discharging switching element 201 (see “second discharging switching element” section and the “nth discharging switching element” section), thereby terminating the discharge of all the capacitors 19 except for the first capacitor 191 (see “second electromagnetic wave radiation circuit” section and the “nth electromagnetic wave radiation circuit” section). At the timing t8, the controller 17 also de-energizes the first charging switching element 211 (see “first charging switching element” section) so as to terminate charging of the first capacitor 191 (see “first electromagnetic wave radiation circuit” section).

At the timing t8, the controller 17 energizes the radiation switching element 16 (see “radiation switching element” section), causing the first electromagnetic wave radiation element 181 to emit light and radiate the measurement light (see “first electromagnetic wave radiation circuit” section). After that, the controller 17 repeats processing similar to that described above, so as to cause light to be emitted from the first electromagnetic wave radiation circuit 151, the second electromagnetic wave radiation circuit 152, . . . , and the nth electromagnetic wave radiation circuit 15n in sequence.

The measurement light radiated from the electromagnetic wave radiation device 10 may be deflected so that the deflection angle is continuously varied. By irradiating the object ob while continuously deflecting the measurement light, the ranging device 11 may function as a scanning ranging sensor.

The detector 13 is capable of detecting light in a band that at least partially overlaps the wavelength band of the measurement light. Therefore, the detector 13 detects reflected scattered light from the measurement light radiated on the object ob, as described above. The detector 13 may notify the controller 14 of detection information indicating that reflected scattered light was detected. The detector 13 is a single element, for example, an APD (Avalanche Photo Diode), a PD (Photo Diode), or a ranging image sensor. Alternatively, the detector 13 may be an element array such as an APD array, a PD array, a ranging imaging array, or a ranging image sensor in a configuration where scanning is not performed by the electromagnetic wave radiation device 10, in other words, in a configuration where the measurement light is radiated across a wide area.

The controller 14 includes one or more processors and memories. Such processors may include at least either of general-purpose processors into which specific programs are loaded in order to perform specific functions and dedicated processors dedicated to specific processing. Dedicated processors may include application specific ICs. Processors may include PLDs. PLDs may include FPGAs. The controller 14 may include at least either of an SoC and an SiP in which one or more processors work together.

Based on the detection of reflected scattered light by the detector 13, the controller 14 generates distance information in the space where the electromagnetic wave radiation device 10 radiated the measurement light. More specifically, the controller 14 may use the ToF (Time-of-Flight) method to generate the distance information, as described below.

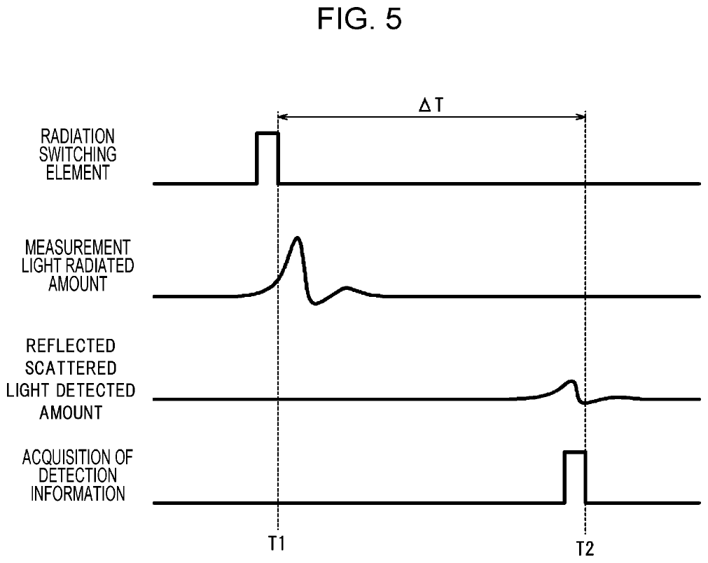

As illustrated in FIG. 5, the controller 14 may energize the radiation switching element 16 via the controller 17 of the electromagnetic wave radiation device 10 (see “radiation switching element” section). The electromagnetic wave radiation element 18 included in the same electromagnetic wave radiation circuit 15 as the charged capacitor 19 may radiate the measurement light based on the energization of the radiation switching element 16 (see “measurement light radiated amount” section). The measurement light radiated by the electromagnetic wave radiation element 18 on any irradiation area on the object ob is reflected from that irradiation area. When the detector 13 detects reflected scattered light reflected in the irradiation area (see “reflected scattered light detected amount” section), the detector 13 notifies the controller 17 of the detection information, as described above.

The controller 17 may include a time measurement LSI (Large Scale Integrated Circuit). The controller 17 may measure a time ΔT from a time T1 when the electromagnetic wave radiation element 18 is made to radiate measurement light to a time T2 when the detection information is acquired (see “acquisition of detection information” section). The controller 17 may calculate the distance to an irradiated position by multiplying the time ΔT by the speed of light and dividing by 2.

As described above, the ranging device 11 is configured to create distance information using Direct ToF, in which the time taken from when the measurement light is radiated until the measurement light returns is directly measured, but the ranging device 11 is not limited to this configuration.

The thus-configured electromagnetic wave radiation device 10 of this embodiment includes: the multiple electromagnetic wave radiation circuits 15, the radiation switching element 16, and the controller 17. Each electromagnetic wave radiation circuit 15 includes the electromagnetic wave radiation element 18, the capacitor 19, and the discharging switching element 20. The radiation switching element 16 is connected to the cathode side of each of the multiple electromagnetic wave radiation elements 18 included in multiple electromagnetic wave radiation circuits 15 and can energize the multiple electromagnetic wave radiation elements 18. The controller 17 discharges the capacitor 19 in any single electromagnetic wave radiation circuit 15, among the multiple electromagnetic wave radiation circuits 15, after causing the electromagnetic wave radiation element 18 in that single electromagnetic wave radiation circuit 15 to radiate light and before causing the electromagnetic wave radiation elements 18 in the other electromagnetic wave radiation circuits 15 to radiate light. With this configuration, the electromagnetic wave radiation device 10 can discharge the charge remaining in the capacitor 19 that powered the electromagnetic wave radiation element 18 after the electromagnetic wave radiation element 18 has radiated light, even while the radiation switching element 16, which is connected to the cathode side of the multiple electromagnetic wave radiation elements 18, is used. Therefore, the electromagnetic wave radiation device 10 can reduce the possibility of double emission.

The electromagnetic wave radiation device 10 of this embodiment starts discharging the capacitor 19 using the discharging switching element 20 in any single electromagnetic wave radiation circuit 15 after energization of the electromagnetic wave radiation element 18 in that single electromagnetic wave radiation circuit 15 and after the prescribed ranging time has elapsed. The discharging of the capacitor 19 can generate noise in surrounding electronic devices. Therefore, for example, the discharging of the capacitor 19 in a configuration in which the detector 13 is disposed near the electromagnetic wave radiation device 10 may result in noise being introduced into the detection signal of the detector 13. As a result, ranging accuracy may be reduced in the ranging device 11, for example. On the other hand, the electromagnetic wave radiation device 10 having the above-described configuration discharges the capacitor 19 after completing ranging, and therefore the effect of generation of noise can be reduced.

The electromagnetic wave radiation device 10 of this embodiment controls the charging switching elements 21 and the discharging switching elements 20 so that the discharging time is longer than the charging time. With this configuration, the electromagnetic wave radiation device 10 can reduce the possibility of charge remaining in the capacitors 19, and therefore the possibility of double emission can be further reduced.

In addition, in the electromagnetic wave radiation device 10 of this embodiment, the gate charge capacity of the discharging switching elements 20 is larger than the gate charge capacity of the charging switching elements 21. With this configuration, the electromagnetic wave radiation device 10 can reduce the possibility of charge remaining in the capacitors 19, and therefore the possibility of double emission can be further reduced.

An embodiment of the electromagnetic wave radiation device 10 has been described above. Embodiments of the present disclosure can be a method or program for implementing a device, as well as a storage medium on which a program is recorded (for example, an optical disk, an optical-magnetic disk, a CD-ROM, CD-R, CD-RW, magnetic tape, hard disk, or memory card, and so on.).

The embodiment of a program is not limited to an application program such as object code compiled by a compiler or program code executed by an interpreter, and can also take the form of a program module or the like incorporated into an operating system. Furthermore, the program may be or not be configured so that all processing is performed only in a CPU on a control board. The program may be configured to be implemented entirely or partially by another processing unit mounted on an expansion board or expansion unit added to the board as necessary.

The drawings illustrating the embodiments of the present disclosure are schematic drawings. The dimensional proportions and so on in the drawings do not necessarily match the actual dimensional proportions and so on.

Although embodiments of the present disclosure have been described based on the drawings and examples, please note that one skilled in the art can make various variations or changes based on the present disclosure. Please note that, therefore, these variations or changes are included within the scope of the present disclosure. For example, the functions and so on included in each constituent part can be rearranged in a logically consistent manner, and multiple constituent parts and so on can be combined into one part or divided into multiple parts.

For example, in this embodiment, the controller 17 energizes all the discharging switching elements 20 except for any one discharging switching element 20 and then starts energizing the charging switching element 21 of the same electromagnetic wave radiation circuit 15 as that one discharging switching element 20, but the controller 17 may instead simultaneously energize all the discharging switching elements 20 except for any one discharging switching element 20 and the charging switching element 21 of the same electromagnetic wave radiation circuit 15 as that one discharging switching element 20. Alternatively, after starting energization of any one charging switching element 21, the discharging switching elements 20 of all the electromagnetic wave radiation circuits 15 except for the same electromagnetic wave radiation circuit 15 as that one charging switching element 21 may be energized. The order in which charging and discharging are performed may be freely chosen so long as charging and discharging in the same electromagnetic wave radiation circuit 15 do not overlap and the discharging of the capacitors 19 in all other electromagnetic wave radiation circuits 15 is completed before radiation is performed in any one electromagnetic wave radiation circuit 15.

All of the constituent elements described in the present disclosure and/or all of the disclosed methods or all of the steps of disclosed processing can be combined in any combination, except for combinations in which their features would be mutually exclusive. Each of the features described in the present disclosure may be replaced by alternative features that serve the same, equivalent, or similar purposes, unless explicitly stated to the contrary. Therefore, unless explicitly stated to the contrary, each of the disclosed features is only one example of a comprehensive set of identical or equivalent features.

Furthermore, the embodiments according to the present disclosure are not limited to any of the specific configurations of the embodiments described above. The embodiments according to the present disclosure can be extended to all novel features, or combinations thereof, described in the present disclosure, or all novel methods, or processing steps, or combinations thereof, described in the present disclosure.

In the present disclosure, “first”, “second,” and so on are identifiers used to distinguish between such configurations. Regarding the configurations, “first”, “second”, and so on used to distinguish between the configurations in the present disclosure may be exchanged with each other. For example, identifiers “first” and “second” may be exchanged between a first electromagnetic wave radiation circuit and a second electromagnetic wave radiation circuit. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.

### REFERENCE SIGNS

10 electromagnetic wave radiation device
11 ranging device
12 mobile object
13 detector
14 controller
15 electromagnetic wave radiation circuit
151 first electromagnetic wave radiation circuit
152 second electromagnetic wave radiation circuit
15n nth electromagnetic wave radiation circuit
16 radiation switching element
17 controller
18 electromagnetic wave radiation element
181 first electromagnetic wave radiation element
182 second electromagnetic wave radiation element
18n nth electromagnetic wave radiation element
19 capacitor
191 first capacitor
192 second capacitor
19n nth capacitor
20 discharging switching element
201 first discharging switching element
202 second discharging switching element
20n nth discharging switching element
21 charging switching element
211 first charging switching element
212 second charging switching element
21n nth charging switching element
22 power supply
23 first resistor
24 second resistor
25 inductor

1. An electromagnetic wave radiation device comprising:
multiple electromagnetic wave radiation circuits, each electromagnetic wave radiation circuit including an electromagnetic wave radiation element, a capacitor configured to supply current to the electromagnetic wave radiation element, and a discharging switching element configured to discharge the capacitor;
a radiation switching element connected to a cathode side of the multiple electromagnetic wave radiation elements included in the multiple electromagnetic wave radiation circuits and configured to be capable of energizing the multiple electromagnetic wave radiation elements; and
a controller configured to discharge the capacitor in any one electromagnetic wave radiation circuit, among the multiple electromagnetic wave radiation circuits, after causing the electromagnetic wave radiation element in the one electromagnetic wave radiation circuit to radiate and before causing the electromagnetic wave radiation element in another electromagnetic wave radiation circuit, among the multiple electromagnetic wave radiation circuits, to radiate.

2. The electromagnetic wave radiation device according to claim 1,
wherein each of the electromagnetic wave radiation circuits includes a charging switching element configured to charge the capacitor of the electromagnetic wave radiation circuit, and
the controller is configured to control the charging switching element and the discharging switching element and make a discharging time longer than a charging time.

3. A ranging device comprising:
the electromagnetic wave radiation device according to claim 2,
wherein the ranging device is configured to measure a distance to an object using an electromagnetic wave radiated from the electromagnetic wave radiation device, and
the controller is configured to start discharging the capacitor in the one electromagnetic wave radiation circuit after elapsing of a prescribed ranging time from after the electromagnetic wave radiation element in the one electromagnetic wave radiation circuit radiates, the ranging time being a time in which a distance to the object is measured by detecting a reflected wave of the electromagnetic wave reflected by the object.

4. The ranging device according to claim 3,
wherein the controller is configured to control the charging switching elements and the discharging switching elements, and charge the capacitor in the one electromagnetic wave radiation circuit and discharge the capacitor in the electromagnetic wave radiation circuit other than the one electromagnetic wave radiation circuit before ranging is performed.

5. The ranging device according to claim 3,
wherein the controller is configured to control the charging switching elements and the discharging switching elements, and not charge the capacitor in the one electromagnetic wave radiation circuit and not discharge the capacitor in the electromagnetic wave radiation circuit other than the one electromagnetic wave radiation circuit while the distance to the object is measured.

6. A mobile object comprising:
the ranging device according to claim 3.
